(19) United States
(12) Patent Application Publication
(10) Pub. No.: US 2026/0184129 A1
(43) Pub. Date: Jul. 2, 2026

(54) VEHICULAR HEALTH MANAGEMENT SYSTEMS AND ASSOCIATED METHODS

(71) Applicant: AMPHION TECHNOLOGY, LLC, Sterling Heights, MI (US)

(72) Inventors: Eric Patton, Shelby Township, MI (US); Robert Matthews, Sterling Heights, MI (US)

(21) Appl. No.: 18/842,920

(22) PCT Filed: Mar. 28, 2024
(86) PCT No.: PCT/US2024/021841

§ 371 Date: Aug. 30, 2024

Related U.S. Application Data
(60) Provisional application No. 63/456,318, filed on Mar. 31, 2023.
(60) Provisional application No. 63/456,737, filed on Apr. 3, 2023.

(51) Int. Cl. B60G 17/0185; G06N 20/00; G07C 5/04

(52) U.S. Cl. CPC B60G 17/0185; G06N 20/00; G07C 5/04; B60G 2600/08; B60G 2600/182

(57) ABSTRACT

A health management system for a vehicle may include, among other things, a computing device including one or more processors coupled to memory. The one or more processors may collectively operable to execute a health management environment. The health management environment may include an interface operable to obtain sensor information from one or more sensors. The health management environment may include a machine learning model operable to determine a health of one or more vehicle components based on at least one training set associated with a vehicle use profile. A method for determining health for a vehicle is also disclosed.

### CROSS-REFERENCE TO RELATED APPLICATION

The present application is a National Phase Entry of International Application No. PCT/US2024/021841 filed Mar. 28, 2024, which claims the benefit of U.S. Provisional Application No. 63/456,318, filed on Mar. 31, 2023, and U.S. Provisional Application No. 63/456,737, filed on Apr. 3, 2023, which are incorporated herein in their entireties.

### BACKGROUND

This disclosure relates to vehicle operation, and more particularly to health management of various components of a vehicle.

Vehicle diagnostics is known and includes a determination of component and/or system degradation based on collected information. Prognostics includes predicting component and/or system degradation based on collected information. The information may be obtained from one or more sensors that measure a condition of the components during vehicle operation. A known technique uses machine learning with inertial sensors on a hull of the vehicle to detect failure of a shock absorber.

### SUMMARY

A health management system for a vehicle may include a computing device including one or more processors coupled to memory. The one or more processors may collectively operable to execute a health management environment. The health management environment may include an interface operable to obtain sensor information from one or more sensors. The health management environment may include a machine learning model operable to determine a health of one or more vehicle components based on at least one training set associated with a vehicle use profile. The vehicle use profile may include sensor information generated by a virtual instance of the one or more sensors.

In any implementations, the health management environment may be operable to cause the at least one training set to include sensor information collected from the one or more sensors during vehicle operation.

In any implementations, the machine learning model may be operable to determine a wear condition of the respective vehicle component based on the sensor information collected from the one or more sensors during vehicle operation. The health management environment may be operable to generate an indicator in response to the wear condition meeting one or more preselected criterion.

In any implementations, the machine learning model may be operable to predict a wear condition of the respective vehicle component based on the sensor information collected from the one or more sensors during vehicle operation. The health management environment may be operable to generate an indicator in response to the predicted wear condition meeting one or more preselected criterion.

In any implementations, the one or more sensors may include a plurality of sensors associated with the respective one or more vehicle components.

In any implementations, the sensors may be spaced apart from each other and/or a centroid of the vehicle.

In any implementations, the one or more vehicle components may include one or more suspension components of a suspension system. The one or more sensors may be operable to measure a condition of the one or more respective suspension components.

In any implementations, the one or more suspension components may include a road wheel and/or a track mounted on the road wheel.

In any implementations, the suspension system may be an adaptive suspension system.

In any implementations, the health management environment may be operable to cause an adjustment of the adaptive suspension system in response to the determined health.

A health management system for a vehicle may include a computing device including one or more processors coupled to memory. The one or more processors may be collectively operable to execute a health management environment. The health management environment may include an interface operable to obtain sensor information from one or more sensors that measure a condition of one or more respective suspension components of a suspension system. The health management environment may include a machine learning model operable to determine a health of the one or more vehicle components based on the sensor information.

In any implementations, the machine learning model may be trained with sensor information generated by a virtual instance of the one or more sensors.

In any implementations, the machine learning model may be trained with sensor information generated by a physical instance of the one or more sensors collected during vehicle operation.

In any implementations, the suspension system may be an adaptive suspension system.

A method for determining health for a vehicle may include obtaining virtual sensor information from one or more virtual sensors operable to measure a condition of a virtual instance of one or more respective vehicle components. The method may include training a machine learning model with the virtual sensor information. The method may include determining a health of a physical instance of the respective one or more vehicle components based on the trained machine learning model.

In any implementations, the method may include obtaining real sensor information measured by one or more physical sensors during vehicle operation. The one or more physical sensors may be associated with the one or more respective virtual sensors. The training step may include training the machine learning model with the real sensor information.

In any implementations, the one or more vehicle components may include one or more suspension components.

In any implementations, the vehicle may be a tracked vehicle. The one or more suspension components may include a road wheel and/or a track mounted on the road wheel.

In any implementations, the training step may include training the machine learning model for only one vehicle associated with a respective suspension configuration.

In any implementations, the training step may include training the machine learning model with sensor information associated with different suspension configurations.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

The embodiments will be better understood from the following detailed description with reference to the drawings, which are not necessarily drawn to scale and in which:

FIG. 1 illustrates a vehicle system including a health management environment; and

FIG. 2 illustrates a diagnostic and prognostic module of the health management environment of FIG. 1.

FIG. 3 discloses a process for determining health for a vehicle.

Like reference numbers and designations in the various drawings indicate like elements.

### DETAILED DESCRIPTION

Vehicular health management systems and associated methods are disclosed, which may include a vehicular sensor-based diagnostic and prognostic system. A method for diagnosing wear states and failures events of vehicular parts, sub-systems and/or systems based on vehicular sensor-based data is disclosed. A method for providing prognostic estimates of wear states and/or failure events of vehicular parts, sub-systems and/or systems based on vehicular sensor-based data is also disclosed.

The disclosed systems and methods may incorporate one or more machine learning models to evaluate a vehicle use profile. The vehicle use profile may be established based on collected sensor data and/or other information. The sensors may be operable to measure or otherwise sense one or more conditions of associated component(s), sub-systems, etc., of the vehicle, such as one or more components of a suspension system of the vehicle. In implementations, one or more sensors may be operable to measure or otherwise sense motion of the respective component. The disclosed systems and methods may incorporate diagnostics to determine wear of one or more components and/or prognostics to predict wear of one or more components, including any of the components disclosed herein. The machine learning model may be trained using training data set(s) for a respective vehicle and/or vehicle type. The machine learning model may be initially trained using a training set including simulated vehicle dynamics modes and one or more virtual sensors associated with the vehicle. The training set may be augmented with actual (e.g., real-time) performance data and/or other information associated with operation of the respective vehicle and one or more physical sensors, which may correspond to the respective virtual sensors. One or more indicators (e.g., alerts) may be generated in response to meeting preselected criteria. In implementations, the alert may be associated with predicted and/or determined wear exceeding one or more preselected thresholds. The system may be operable to cause one or more changes to a configuration of the vehicle suspension in response to the preselected criterion or criteria being met. Maintenance personnel may utilize the alert(s) to perform a maintenance action.

Sensor information from one or more sensors may be provided as input (e.g., as a training data set) to the machine learning model(s) to provide enhanced prediction capability for failures and a more definitive vehicle use profile. The sensors may include one or more inertial sensors (e.g., accelerometer, gyroscope, etc.). The disclosed system may be operable to obtain sensor information from other sensors such as, but not limited to, one or more sensors operable to determine relative movement of the component(s) and vehicle chassis (e.g., hull), including suspension travel and/or speed, track tension (e.g., for tracked platforms), drive train motion, etc., which may provide for a more thorough vehicle use case (e.g., use case profile) as compared to techniques which may infer use based upon the motion of a sensor pack located at or otherwise adjacent to the centroid of the vehicle. In the case of failure detection, including sensors spread through vehicle (e.g., suspension) subsystems may provide improved detection of vibration and movements within those subsystems that may otherwise be lost within the noise and inefficiencies (e.g., frictional losses) when translated to the vehicle centroid through many mechanical linkages. By placing sensors within the subsystems disclosed herein and interrelating their data streams to that of the vehicle as a whole (and/or other subsystems), a synergistic benefit may be gained by analyzing the data as a whole.

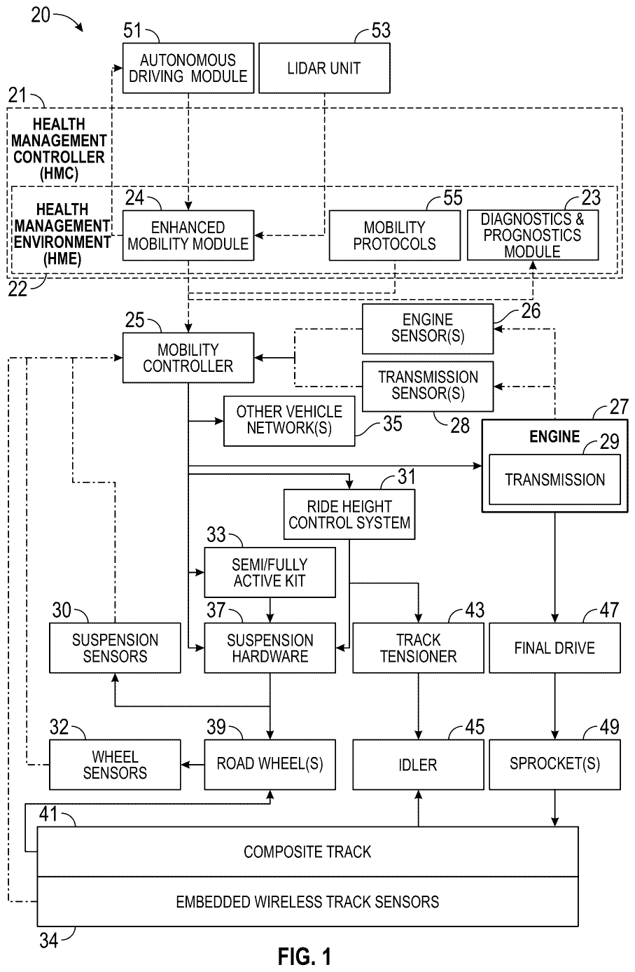

FIG. 1 illustrates a system 20 (e.g., vehicle mobility or suspension system) that may include a health management computing device (e.g., controller) (HMC) 21. The HMC 21 may be operable to execute a health management environment (HME) 22. The HME 22 may include one or more modules, or subsystems, such as a diagnostic and prognostic module 23 and an enhanced mobility module 24. The modules 23, 24 may be operable to communicate with a mobility computing device (e.g., processor or controller) 25.

The mobility controller 25 may be operable to communicate with one or more mobility subsystems, including any of the subsystems disclosed herein, such as ride height control system 31, semi- and/or fully-active kit 33, and/or other vehicle networks 35. The ride height control system 31 may be operable to control operation of various components of the vehicle, such as suspension hardware 37, road wheel(s) 39, (e.g., composite) track 41, track tensioner 43 and/or idler 45. The track 41 may be mounted on the road wheel(s) 39.

The mobility controller 25 may be operable to receive sensor data from one or more sensors associated with various components of a vehicle, including any of the sensors disclosed herein. The sensors may be distributed at different positions relative to each other, including different positions within and/or on the vehicle such that the sensors may be spaced apart from each other and/or a centroid of the vehicle. In implementations, the HMC 21 and/or HME 22 may be incorporated into the mobility controller 25, or vice versa. Various vehicles may benefit from the teachings disclosed herein, including on-road and/or off-road vehicles such as wheeled and/or tracked vehicles.

The HMC 21 and/or mobility controller 25 may include one or more computer processors, memory, storage means, network devices, input and/or output devices, and/or interfaces. The HMC 21 and/or mobility controller 25 may be operable to execute one or more software programs. The HMC 21 and/or mobility controller 25 may be operable to communicate with one or more networks established by one or more computing devices. The memory may include UVPROM, EEPROM, FLASH, RAM, ROM, DVD, CD, a hard drive, or other computer readable medium which may store data and/or the functionality of this description. The HMC 21 and/or mobility controller 25 may be a desktop computer, laptop computer, smart phone, tablet, or any other computer device. Input devices may include a keyboard, mouse, touchscreen, etc. The output devices may include a monitor, speakers, printers, etc. The HMC 21 and/or mobility controller 25 may include one or more processors coupled to memory. The connection may be a wired and/or wireless connection. The connection may be established over one or more networks and/or other computing systems. The HMC 21 and/or mobility controller 25 may be programmed with logic to perform any of the functionality disclosed herein. In implementations, processing of the various data and other information disclosed herein may be performed by the HMC 21 and/or mobility controller 25 either onboard and/or offboard the vehicle.

The mobility controller 25 may be operable to receive (e.g., wired) sensor data (illustrated as dash-dot lines) from corresponding engine sensor(s) 26, transmission sensor(s) 28, vehicle suspension sensors 30, and/or vehicle wheel sensors 32, and/or (e.g., wireless) sensor data (illustrated as dash-double-dot lines) from embedded track sensors 34 associated with the (e.g., composite) track 41 of a tracked vehicle.

### Sensor Data Collection

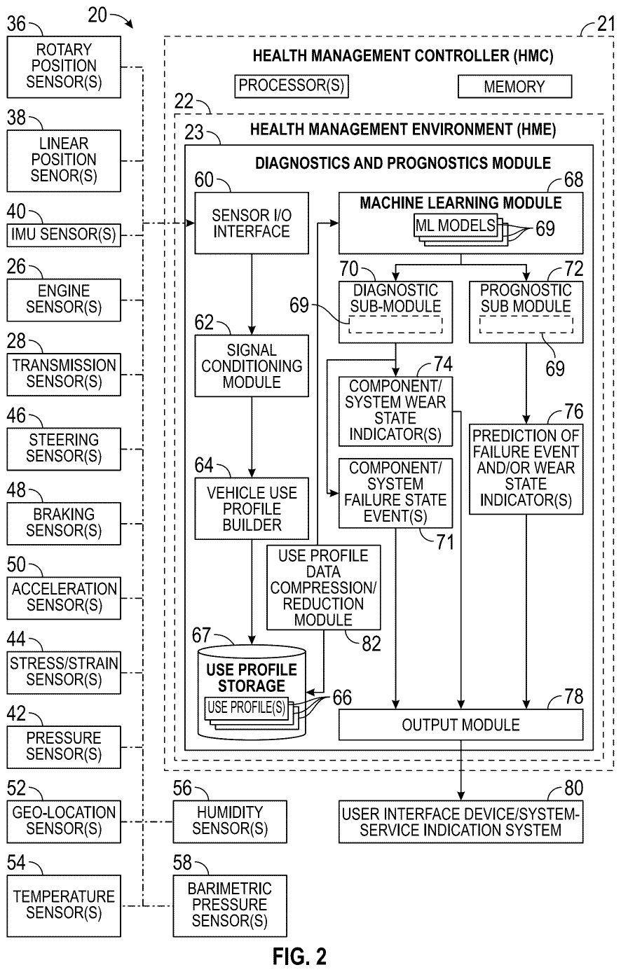

Referring to FIG. 2, with continuing reference to FIG. 1, and with respect to each of the above-described sensors, different types of sensors may provide corresponding sensor data from various components and sub-systems of the vehicle, including any of the sensors, components and sub-systems disclosed herein. With respect to vehicular suspension hardware (e.g., system) 37, rotary position sensor(s) 36 may be operable to collect and/or communicate real-time rotary position sensor data. Linear position sensor(s) 38 may be operable to collect and/or communicate linear position sensor data. The sensors may include one or more inertial motion sensors (e.g., Inertial Motion Unit, “IMU”) 40, such as an accelerometer, gyroscope, etc. The inertial motion sensor(s) 40 may be operable to collect and/or communicate 3-axis inertial sensor data. Pressure sensor(s) 42 may be operable to collect and/or communicate internal pressure (e.g., hydraulic) sensor data. Stress and/or strain gauge sensor(s) 44 may be operable to collect and/or communicate stress and/or strain gauge sensor data with respect to various suspension components (e.g., hardware) 37 of a vehicle, the vehicle hull, a wheel 39 or a plurality of wheels 39 of a vehicle, and/or a track 41 of a tracked vehicle.

With respect to engine and transmission sensors 26, 28, engine sensors 26 may be operable to collect and/or communicate real-time RPM, load and throttle position data. Transmission sensors 28 may be operable to collect real-time input RPM, output RPM, direction and/or gear selection data of the vehicle. Both the engine 27 and transmission 29 may be operable to receive brake commands associated with the respective (e.g., tracked) vehicle(s). A final drive 47 and sprocket 49 may be associated with the engine 27 and transmission 29 and/or the track 41.

The enhanced mobility module 24 and/or another portion of the HME 22 may be operable to communicate with an autonomous driving module 51 and/or a navigational subsystem such as a light detection and ranging (LIDAR) unit 53. The enhanced mobility module 24 may be operable to assist in route planning based on a determined and/or predicted wear state of the vehicle component(s) utilizing any of the techniques disclosed herein.

The various subsystems and components may communicate or otherwise interface via one or more predefined mobility protocols 55.

With respect to vehicle dynamic performance characteristics, one or more steering sensors 46 may be operable to collect realtime vehicular steering data. One or more braking sensors 48 may be operable to collect realtime braking data. One or more acceleration sensors 50 may be operable to collect realtime acceleration data.

Additional sensors that may be characterized as non-specific to a vehicle platform may be operable to collect and/or communicate data related to a geographic location and atmospheric conditions to better predict wear rates and failure modes based on geographic locations (e.g., abrasive sand parameters of a particular arid location, or corrosive sea water-based humidity in coastal tropical locations). The sensors may be onboard the vehicle or may be remotely located from the vehicle and may be operable to communicate data utilizing any of the techniques disclosed herein.

Geo-location sensor(s) 52 (e.g., Global Positions System (GPS) receivers), temperature sensor(s) 54, humidity sensor(s) 56 and/or barometric pressure sensor(s) 58 may be operable to provide this data, which may be utilized to better predict wear rates and failure modes particularly when vehicle(s) may be operated in diverse geographies and climates over their operational service life.

The mobility controller 25 may be operable to communicate the collected sensor signal data to the diagnostic and prognostic module 23.

FIG. 2 illustrates the diagnostic and prognostic module 23 of FIG. 1.

### Signal Conditioning

The diagnostics and prognostics module 23 may include various sub-modules to provide the disclosed functionality, including signal conditioning. The diagnostics and prognostics module 23 may include a sensor input/output (I/O) interface 60. The sensor I/O interface 60 may be operable to collect and communicate the sensor data output from any of the sensors disclosed herein, including the rotary position sensor(s) 36, linear position sensor(s) 38, IMU sensor(s) 40, pressure sensor(s) 42, engine sensor(s) 26, transmission sensor(s) 28, steering sensor(s) 46, braking sensor(s) 48, acceleration sensor(s) 50 and stress/strain sensor(s) 44. The sensor I/O interface 60 may be operable to feed or otherwise communicate the accumulated sensor data taken from the vehicle in real-time to a signal conditioning module 62.

The signal conditioning module 62 may be operable to translate sensor data signals into any number of calculated parameters such as a linear distance, an angular rotation, a linear and/or angular velocity, a linear or angular acceleration, and a stress and/or strain value. The signal conditioning module 62 may be programmed with logic to perform the translation of the sensor data. For example, the signal conditioning module 62 may be operable to determine wheel 39 position data (d) from a linear sensor or an angular sensor mounted on suspension hardware 37 from which the signal conditioning module 62 may differentiate over time to calculate wheel 39 velocity data (d/t).

### Vehicle Use Profile

The signal conditioning module 62 may be operable to send or otherwise communicate the conditioned signal data to a vehicle use profile builder 64. The vehicle use profile builder 64 may be operable to create, store and/or update a (e.g., vehicle) use profile 66 for each vehicle that the diagnostic and prognostics module 23 may be operating upon. The vehicle use profile builder 64 may be operable to associate the use profile 66 with any and/or all of the (e.g., sensed or accumulated) virtual and/or real sensor data for the respective vehicle. For example, a use profile 66 for a specific vehicle may be based on all of the accumulated wheel position data and wheel velocity data for that specific vehicle. Additionally, the use profile 66 may further include engine sensor data, transmission sensor data, vehicle dynamic handling sensor data, geolocation data and atmospheric data to provide a more complete representation of forces, conditions and incidents that may affect components of the vehicle during its operational life.

### Machine Learning

The diagnostics and prognostics module 23 may include a machine learning (ML) module 68. The machine learning module 68 may include one or more machine learning models 69. Various machine learning models may be utilized, such as a neural network. The machine learning model(s) 69 may be trained with one or more supervised and/or unsupervised training data sets. After a vehicle use profile 66 is initially created, the machine learning module 68 may be operable to examine the vehicle use profile 66 with a diagnostic sub-module 70 and/or a prognostic sub-module 72. The diagnostic sub-module 70 and/or prognostic sub-module 72 may be associated with one or more respective machine learning model(s) 69 and/or associated training sets. The training sets may be the same or may differ from each other.

The training data sets may be established and/or otherwise associated with any of the data and information disclosed herein. The training sets may include sensor data generated by, or otherwise associated with, virtual and/or physical (e.g., real) instances of sensor(s), including any of the sensors disclosed herein. The virtual sensor may be associated with a virtual representation (e.g., instance) of a physical sensor. Operation of a virtual representation of the physical vehicle and associated physical sensor(s) may be simulated in a virtual environment with the respective virtual sensor(s). The virtual environment may be utilized to simulate vehicle dynamics associated with operation of virtual model of the vehicle relative to a virtual terrain. Each virtual sensor may generate the same type of data as the respective physical sensor such that the virtual and/or real sensor data may be captured in the training set and presented to the machine learning model 69 in the same manner. In implementations, the virtual and/or real sensor data in the training set may be indistinguishable by the machine learning model 69. Use of simulated sensor data may facilitate relatively quicker training of the machine learning model 69 than by use of real sensor data alone. Additionally, failure modes may be injected into the virtual sensor data to facilitate training of the machine learning model 69, whereas training the machine learning model 69 with only actual component failures may demand substantially greater amounts of real world operation of the vehicle to accomplish a similar level of training. In implementations, the training sets may include sensor information associated with travel of an arm supporting a road wheel 39 and pressure sensor(s) associated with an actuator of the track tensioner 43.

The machine learning model(s) 69 may be trained with one or more training sets based on an operating environment of the vehicle. The operating environment may be associated with simulated and/or real sensor data, including sensor data generated by one or more onboard and/or offboard environmental sensors such as the geo-location sensor(s) 52, temperature sensor(s) 54, humidity sensor(s) 56 and/or barometric pressure sensor(s) 58. The sensed environmental conditions may be stored in, or otherwise may be associated with, a respective vehicle use profile 66. The machine learning model(s) 69 may be incorporated into an open-loop system. The machine learning module 68 may be operable to update the vehicle use profile 66 and/or training set(s) associated with the machine learning model(s) 69 to include sensor data collected during actual use of the vehicle. The machine learning model(s) 69 may continue to be trained based on the updated sensor data.

The diagnostic sub-module 70 may be operable to analyze the vehicle use profile 66 to determine one or more states (e.g., conditions) of a vehicle component or a system, which may be associated with a wear (e.g., failure) state event. The diagnostic sub-module 70 may be operable to generate one or more indicators (e.g., indications) in response to one or more preselected criterion being met. The diagnostic sub-module 70 may be operable to generate one or more wear state indicators (e.g., indications) 74 in response to a condition associated with a component or system within the vehicle meeting a preselected wear state value or parameter (e.g., threshold). The diagnostic sub-module 70 may be operable to generate one or more system failure state indicators (e.g., indications) 76 in response to determining a failure of a component or system within the vehicle. The diagnostic sub-module 70 may be operable to indicate the particular component or system associated with the determined wear and/or failure, which may be communicated to the enhanced mobility module 24 for assisting in route planning and execution.

The prognostic sub-module 72 may be operable to analyze the vehicle use profile 66 to predict the wear state associated with a component or system within the vehicle based on an estimate in time of reaching the wear state and/or a failure event based on an estimate in time of reaching the failure event. For example, a prediction of a future failure of a vehicle component may be based on wear patterns or a calculated mean time before failure. The failure state may be diagnosed through indicative sensor data readings from past failures. For example, a specific vibration state on the vehicle may indicate a pending failure of vehicle sprocket 49 failure.

The machine learning model(s) 69 may be trained for each particular vehicle to account for different vehicle components, sub-systems and systems, including different suspension configurations. The machine learning model(s) 69 may be initially trained using simulated vehicle dynamics model information and subsequently by real-time vehicle information during its operational life. This operational data may, or may not, lead to additional specific failure models for individual vehicle use types. For example, the vehicle may develop specific failure models for operation in arctic type conditions, that may be substantially or completely different from operation in desert conditions. These two disparate models, developed from vehicle data in separate regions, may be recombined as a larger model update with training in the machine learning model 69 to differentiate when to use each failure model.

The diagnostic sub-module 70 and/or the prognostic sub-module 72, upon an indication of a wear state, a diagnosis of a failure event, or the prediction of either of these, may be operable to communicate to the diagnostics and/or prognostics information, including the indicators 74, 76, to an output module 78. Various techniques may be utilized to communicate the information. The output module 78 may be operable to send a signal or a communication to a user interface device (e.g., system) 80. The user interface device 80 may be operable to alert a user or corresponding user system of the indication of the wear state, diagnosis of the failure event and/or the prediction thereof, such as a driver or other operator of the vehicle. In implementations, the diagnostic sub-module 70 and/or the prognostic sub-module 72 may be operable to send a (e.g., automated) message to a computing device accessible by maintenance personnel, either remotely or upon the vehicle arriving at a depot or resupply area. The information may be communicated to other vehicles through a communications (e.g., mesh) network.

For tracked vehicles, two of the most common wear (e.g., consumable) items may include the track 41 and road wheels 39. In implementations, the road wheels 39 and track 41 may be associated with respective sensors 32, 34. The machine learning model(s) 69 associated with the diagnostic sub-module 70 and/or the prognostic sub-module 72 may be trained to determine and/or predict a wear (e.g., failure) state of the road wheels 39 and/or track 41. The determined or predicted wear state may be communicated to the mobility controller 25, enhanced mobility module 24, and/or a vehicle operator for taking appropriate action.

As sensor data is accumulated in real-time over the operational periods of the vehicle, the machine learning module 68 may be operable to update the vehicle use profile 66 with the sensor data and store that updated vehicle user profile 66 in a use profile storage 67 for future reference and updating. The storage 67 may be established in memory. The memory may be associated with the HMC 21 or may be a separate storage device such as a storage area network device (SAN) operable to communicate with the HMC 21 over a communications network and/or data bus.

The HME 22 may be operable to cause an adjustment of an adaptive suspension system of the vehicle in response to the (e.g., diagnosed and/or predicted) health of the vehicle component(s) determined by the machine learning model(s) 69. In implementations, the HME 22 may be operable to selectively cause the mobility controller 25 to adjust one or more parameters of an adaptive suspension system of the vehicle, such as the ride height control system 31, in response to a diagnosed and/or predicted wear state of one or more suspension components previously determined by the machine learning model(s) 69. The mobility controller 25 may be operable to selectively adjust the ride height control system 31 in response to receiving one or more messages (e.g., requests) from the HME 22 associated with the determined health.

### Data Reduction

The diagnostics and prognostics module 23 may include a use profile compression/reduction module 82. As sensor data is accumulated over the operational life of the vehicle, the use profile compression/reduction module 82 may be operable to reduce the use profile 66 to maintain a manageable set of stored data in the user profile 66, which may reduce memory storage demands onboard and/or offboard the vehicle. For example, in a tracked vehicle with 12-wheel stations, the storage requirements may become too large as the operational life of the vehicle continues. Therefore, the vehicle use profile 66 compression/reduction module 82 may include an algorithm operable to either reduce the vehicle use profile 66, compress the vehicle use profile 66, and/or create a mathematical representation of the vehicle use profile, wherein each alternative may be still updated with the collected sensor data over the operational life of the vehicle.

The reduced, compressed or mathematically represented vehicle use profile 66 may then be stored in the use profile storage 67 to be continuously updated with the real-time sensor data over the operational life of the vehicle.

Data compression/reduction may occur before training the machine learning model(s) 69 or after training the machine learning model(s) 69 with the real-time sensor data.

### Third Party Components and Systems

A third-party supplier (e.g., vendor) that provides components or systems to a vehicle platform may share a component or subsystem failure model to be acted upon by the diagnostic module 70 and/or prognostic module 72 to further predict failures of third-party components parts. This may allow software-based third-party failure module(s) to use the collected vehicle use profile 66 in predicting wear on third-party components and systems without disclosure of the proprietary failure model.

### Methods of Determining Vehicle Health

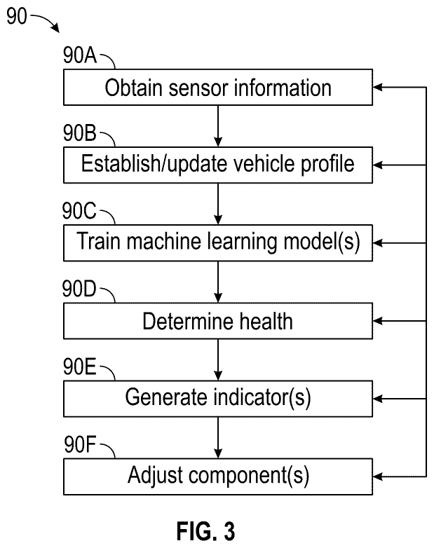

FIG. 3 discloses a method 90 in a flowchart for determining the health of components of a vehicle according to an implementation. The components and vehicle may include any of those disclosed herein. The health management controller 21 and/or associated modules may be operable to execute any of the functionality of the method 90 and/or techniques disclosed herein. Reference is made to the system 20 of FIGS. 1-2.

At block 90A, sensor information may be obtained. The sensor information may be obtained from any of the sensors disclosed herein, including virtual and/or physical instances of the sensor(s). The sensor information may be captured during simulated and/or real operation of the vehicle. Block 90A may include obtaining virtual sensor information from one or more virtual sensors. The virtual sensor(s) may be operable to measure a condition of a virtual instance of one or more respective vehicle components and/or operating environment of the vehicle. The vehicle components may include any of the components disclosed herein. Block 90A may include obtaining real sensor information measured by one or more physical sensors during vehicle operation. The physical sensor(s) may be associated with the respective virtual sensor(s).

The vehicle component(s) may include one or more suspension components (e.g., hardware) 37. In implementations, the vehicle may be a tracked vehicle or a wheeled vehicle. The suspension component(s) 37 may include road wheel(s) 39 and/or a track 41 mounted on the road wheel(s) 39.

At block 90B, a vehicle use profile 66 may be established and/or updated. The vehicle use profile 66 may include the sensor information. The vehicle use profile 66 may be established and/or updated using any of the techniques disclosed herein.

At block 90C, one or more machine learning models 69 may be trained. The machine learning model(s) 69 may be trained utilizing any of the techniques disclosed herein, including supervised and/or unsupervised techniques. The machine learning model 69 may be trained with the virtual and/or real sensor information.

The machine learning model(s) 69 may be trained for only one vehicle or vehicle type, or may be trained for a fleet of vehicles, which may include respective suspension configurations. The machine learning model(s) 69 may be trained for one or more operating environments of the respective vehicle(s). In implementations, the machine learning model 69 may be trained for only one vehicle associated with a respective suspension configuration. The suspension configuration may be adaptive. The machine learning model 69 may be trained with virtual and/or real sensor information associated with different suspension configurations for the same and/or different vehicles and/or vehicle types.

At block 90D, a health of the vehicle and/or one or more vehicle components may be determined. The health may be determined utilizing any of the techniques disclosed herein. Block 90D may include determining a health of a physical and/or virtual instance of the respective vehicle component(s) based on the trained machine learning model(s) 69. The determined health may include diagnostics and/or prognostics for the respective vehicle component(s).

At block 90E, one or more indicators 74, 76 may be generated. The indicators 74, 76 may be generated utilizing any of the techniques disclosed herein.

At block 90F, one or more vehicle components and/or subsystems of the vehicle may be adjusted based on the determined health. Block 90F may include adjusting one or more suspension components, including any of the suspension components disclosed herein such as an adaptive suspension.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

What is claimed is:

1. A health management system for a vehicle comprising:
a computing device including one or more processors coupled to memory, the one or more processors collectively operable to execute a health management environment, and the health management environment comprising:
an interface operable to obtain sensor information from one or more sensors; and
a machine learning model operable to determine a health of one or more vehicle components based on at least one training set associated with a vehicle use profile, the vehicle use profile including sensor information generated by a virtual instance of the one or more sensors.

2. The system as recited in claim 1, wherein:
the health management environment is operable to cause the at least one training set to include sensor information collected from the one or more sensors during vehicle operation.

3. The system as recited in claim 1, wherein:
the machine learning model is operable to determine a wear condition of the respective vehicle component based on the sensor information collected from the one or more sensors during vehicle operation; and
the health management environment is operable to generate an indicator in response to the wear condition meeting one or more preselected criterion.

4. The system as recited in claim 1, wherein:
the machine learning model is operable to predict a wear condition of the respective vehicle component based on the sensor information collected from the one or more sensors during vehicle operation; and
the health management environment is operable to generate an indicator in response to the predicted wear condition meeting one or more preselected criterion.

5. The system as recited in claim 1, wherein the one or more sensors include a plurality of sensors associated with the respective one or more vehicle components.

6. The system as recited in claim 5, wherein the sensors are spaced apart from each other and/or a centroid of the vehicle.

7. The system as recited in claim 1, wherein:
the one or more vehicle components include one or more suspension components of a suspension system; and
the one or more sensors are operable to measure a condition of the one or more respective suspension components.

8. The system as recited in claim 7, wherein the one or more suspension components include a road wheel and/or a track mounted on the road wheel.

9. The system as recited in claim 7, wherein the suspension system is an adaptive suspension system.

10. The system as recited in claim 9, wherein the health management environment is operable to cause an adjustment of the adaptive suspension system in response to the determined health.

11. A health management system for a vehicle comprising:
a computing device including one or more processors coupled to memory, the one or more processors collectively operable to execute a health management environment, and the health management environment comprising:
an interface operable to obtain sensor information from one or more sensors that measure a condition of one or more respective suspension components of a suspension system; and
a machine learning model operable to determine a health of the one or more vehicle components based on the sensor information.

12. The system as recited in claim 11, wherein the machine learning model is trained with sensor information generated by a virtual instance of the one or more sensors.

13. The system as recited in claim 11, wherein the machine learning model is trained with sensor information generated by a physical instance of the one or more sensors collected during vehicle operation.

14. The system as recited in claim 11, wherein the suspension system is an adaptive suspension system.

15. A method for determining health for a vehicle comprising:
obtaining virtual sensor information from one or more virtual sensors operable to measure a condition of a virtual instance of one or more respective vehicle components;
training a machine learning model with the virtual sensor information; and
determining a health of a physical instance of the respective one or more vehicle components based on the trained machine learning model.

16. The method as recited in claim 15, further comprising:
obtaining real sensor information measured by one or more physical sensors during vehicle operation, the one or more physical sensors associated with the one or more respective virtual sensors; and
the training step includes training the machine learning model with the real sensor information.

17. The method as recited in claim 15, wherein:
the one or more vehicle components include one or more suspension components.

18. The method as recited in claim 17, wherein the vehicle is a tracked vehicle, and the one or more suspension components include a road wheel and/or a track mounted on the road wheel.

19. The method as recited in claim 15, wherein the training step includes training the machine learning model for only one vehicle associated with a respective suspension configuration.

20. The method as recited in claim 15, wherein the training step includes training the machine learning model with sensor information associated with different suspension configurations.
